(19) United States
(12) Patent Application Publication
(10) Pub. No.: US 2026/0092144 A1
(43) Pub. Date: Apr. 2, 2026

(54) Method For Recycling Polyamide 66 Waste Products

(71) Applicant: Celanese Polymers Holding, Inc., Wilmington, DE (US)

(72) Inventors: Omar Garcia Valdez, Kingston (CA); Ahmet Turgut Mutel, Napanee (CA); Ramin Radmanesh, Kingston (CA)

(21) Appl. No.: 19/344,800

(22) Filed: Sep. 30, 2025

Related U.S. Application Data
(60) Provisional application No. 63/701,763, filed on Oct. 1, 2024.

(51) Int. Cl. C08G 69/28; C08G 69/46

(52) U.S. Cl. CPC C08G 69/28; C08G 69/46

(57) ABSTRACT

A method for recycling a polyamide 66 waste feedstock is provided. The method comprises separating an oligomeric mixture within a filtration unit and repolymerizing the polyamide 66 oligomer. The oligomeric mixture contains adipic acid, a polyamide 66 oligomer derived from the waste feedstock, and impurities, and the separation results in the formation of a solid cake containing the impurities and a liquid stream containing the polyamide 66 oligomer and adipic acid.

### RELATED APPLICATION

The present application is based upon and claims priority to U.S. Provisional Patent Application Ser. No. 63/701,763, having a filing date of Oct. 1, 2024, which is incorporated herein by reference.

### BACKGROUND OF THE INVENTION

Polyamide 66 (“PA66” or “Nylon 66”) is used extensively in a variety of industrial and consumer products, such as carpets and automotive parts. In many of these products, PA66 is blended with other ingredients (e.g., glass fibers, impact modifiers, pigments, inorganic particles (e.g., titanium dioxide), other polymers (e.g., PA6), etc.) to form polymer compositions having certain target properties. To increase the sustainable content of such polymer compositions, it would be highly desirable to be able to recycle PA66 compositions that have either been used commercially (e.g., “post-consumer”) or in industry (e.g., “post-industrial”). However, the ability to recycle such compositions is often problematic due to the presence of impurities, such as the ingredients noted above, dirt, etc., which cannot be easily removed by mechanical means alone. Of course, attempts have even been made to use dissolution and filtration systems to remove these impurities, but such processes are generally inefficient and can result in poor properties of the recycled PA66. As such, a need currently exists for an improved technique for recycling PA66 from waste products.

### SUMMARY OF THE INVENTION

In accordance with one embodiment of the present invention, a method for forming an oligomeric mixture containing a polyamide 66 oligomer is disclosed. The method comprises comprising heating a reaction mixture within a reactor vessel that contains adipic acid, water, and a waste feedstock that includes polyamide 66 and one or more impurities. The waste feedstock may, for instance, be derived from a post-industrial recycled material and/or a post-consumer recycled material. A weight ratio of the adipic acid to the polyamide 66 is less than 1:1.

In accordance with another embodiment of the present invention, an oligomeric mixture is disclosed that contains a polyamide 66 oligomer, adipic acid, and impurities. The melting temperature of the oligomeric mixture may be from about 110° C. to about 220° C. as determined by differential scanning calorimetry in accordance with ISO 11357-1:2023 and/or the viscosity of the solution may be less than about 120 centipoise, as determined using a Brookfield viscometer at a temperature of 155° C. and shear rate of 15 s⁻¹. Further, the polyamide 66 oligomer may have amino end groups and carboxyl end groups, wherein the ratio of the amino end groups to the carboxy end groups is from about 0.1 to about 0.8. The polyamide 66 oligomer may also have an inherent viscosity of from about 0.1 to about 0.6 deciliters per gram as determined at a temperature of 25° C.

In accordance with yet another embodiment of the present invention, a method for recycling a polyamide 66 waste feedstock is disclosed. The method comprises separating an oligomeric mixture and repolymerizing the polyamide 66 oligomer. The oligomeric mixture contains adipic acid, a polyamide 66 oligomer derived from the waste feedstock, and impurities, and the separation results in the formation of a solid cake containing the impurities and a liquid stream containing the polyamide 66 oligomer and adipic acid. In one embodiment, the polyamide 66 oligomer is precipitated from the liquid stream and thereafter repolymerized. In another embodiment, the liquid stream is supplied to a polymerization system to repolymerize the polyamide 66 oligomer.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a schematic illustration of one embodiment a PA66 recycling method of the present invention;

FIG. 2 is a schematic illustration of another embodiment of a PA66 recycling method of the present invention; and

FIG. 3 is a graph showing the viscosity of samples containing an impurity level of 20%, 25%, and 33% from Example 10 at various shear rates (temperature of 155° C.).

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a method for recycling a waste product that contains polyamide 66 (“PA66”). More particularly, the method includes forming an oligomeric mixture from the PA66 waste product, adipic acid, and water. Through selective control over the particular dissolution conditions, it has been discovered that the resulting solution may form a eutectic mixture in that it can have a melting temperature lower than pure PA66 (e.g., about 255 to 266° C.). Namely, the melting temperature of the oligomeric mixture is typically from about 110° C. to about 265° C., in some embodiments from about 120° C. to about 240° C., in some embodiments from about 130° C. to about 230° C., and in some embodiments, from about 140° C. to about 190° C. such as determined by differential scanning calorimetry in accordance with ISO 11357-1:2023 (during 2^{nd} heat cycle). Once formed, the resulting oligomeric mixture may be subjected to a separation process to separate the solution into a solid cake containing insoluble impurities and a liquid stream containing depolymerized PA66 oligomer(s) and adipic acid. The liquid stream may then be repolymerized to form PA66 having the desired molecular weight. The use of adipic acid in the recycling process has a multitude of benefits over other conventional techniques for recycling PA66. For example, adipic acid is already part of the typical PA66 supply chain, and thus the recycling process can be more efficiently integrated to an existing PA66 facility (e.g., in a polymerization step, batch process, or post-polymerization step during compounding). Further, unlike other solvents that have been used in solvent-based recovery, the reaction between adipic acid and PA66 in the recovered nylon can be better tolerated.

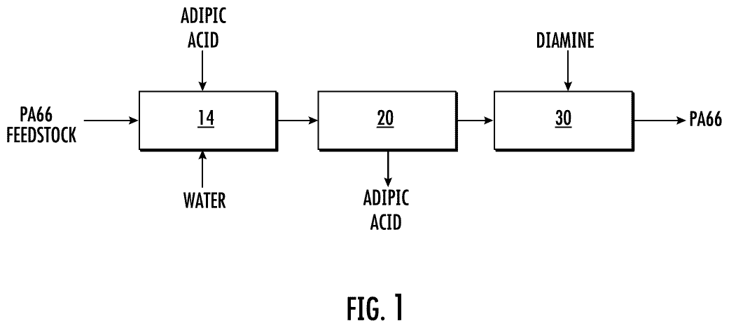

Referring to FIG. 1, one particular embodiment of the recycling method of the present invention is shown in more detail. More particularly, a PA66 feedstock is initially provided to a reactor vessel, which typically derived from a “post-consumer recycled” (“PCR”) and/or “post-industrial recycled” (“PIR”) material. The design of the reactor vessel 14 is not critical. Examples of suitable reactors include stirred autoclaves, unstirred autoclaves, column reactors, tube reactors, loop reactors, etc. The process is generally conducted in the absence of air. The air may be removed by any known process, such as by purging the reactor with inert gases, including nitrogen or argon, evacuating the reactor and filling it with inert gases, and pressurizing the reactor with inert gases.

The term “post-consumer” generally refers to a material that has reached the intended end user or consumer, and which is no longer being used for the intended purpose, and which has been collected or reclaimed after utilization by the end-user or consumer. Thus, for example, the term refers to a material that would have otherwise been disposed of as waste, but has instead been collected and recovered (reclaimed) as a material input, in lieu of new virgin material, for a recycling or manufacturing process. The term includes such collected or reclaimed materials, even if they have been further treated or processed to facilitate re-use of the material. Thus, for example, the term includes a material that has been reprocessed from collected or reclaimed material by means of a manufacturing process and made into a product or into a component for incorporation into a product. Examples of such products may include, for instance, carpet (e.g., carpet components), clothing, automotive parts, etc.

The term “post-industrial” generally refers to a material that has not reached the end user and that is production waste arising during polymerization reactions, e.g., polymerization, during further processing, or during manufacturing an article and includes materials such as, but not limited to, sprues from injection molding, start-up material from injection molding or extrusion, extrusion scrap, molding scrap, edge trims from extruded sheets or films, and the like, including materials diverted from the waste stream during a manufacturing process for an article, and wherein the materials are collected or reclaimed for re-use and/or re-processing. Thus, for example, the term includes material that would have otherwise been disposed of as waste or used for energy recovery, but has instead been collected and recovered (reclaimed) as a material input, in lieu of new virgin material, for a recycling or manufacturing process. The term includes such collected or reclaimed materials that have been further treated or processed to facilitate re-use of the material, such as material that has been reprocessed from collected or reclaimed material by means of a manufacturing process and made into a product or into a component for incorporation into a product. Post-industrial recycled material thus includes regrind materials, rework materials, and scrap materials.

The PA66 waste product (and resulting feedstock) generally contains PA66 in addition to one or more impurities. The content of PA66 in the waste product is typically from about 50 wt. % to about 99 wt. %, in some embodiments from about 65 wt. % to about 95 wt. %, and in some embodiments, from about 70 wt. % to about 90 wt. %. The impurity content is likewise typically from about 1 wt. % to about 50 wt. %, in some embodiments from about 5 wt. % to about 35 wt. %, and in some embodiments, from about 10 wt. % to about 30 wt. %. The nature of the impurities may vary depending on the product from which the feedstock is derived. For example, the impurities may include other polymers (e.g., polyolefins, such as polypropylene), inorganic material (e.g., titanium dioxide, calcium carbonate, carbon black, glass fibers, etc.).

Regardless of its constituents, the waste product may be employed as is or converted into the desired form for the PA66 feedstock in a variety of different ways. In one embodiment, for example, the waste product may be initially ground into the form of a particulate feedstock material. Any suitable known grinding equipment (wet or dry) may be employed, such as jaw crusher, gyratory crusher, cone crusher, roll crusher, impact crusher, hammer crusher, cracking cutter, rod mill, ball mill, vibration rod mill, vibration ball mill, pan mill, roller mill, impact mill, discoid mill, stirring grinding mill, fluid energy mill, jet mill, etc. Jet milling, for instance, typically involves the use of a shear or pulverizing machine in which the polymer is accelerated by gas flows and pulverized by collision. Any type of jet mill design may be employed, such as double counterflow (opposing jet) and spiral (pancake) fluid energy mills. Gas and particle flow may simply be in a spiral fashion, or more intricate in flow pattern, but essentially particles collide against each other or against a collision surface. In certain embodiments, it may be desired to mill the waste product in the presence of a cryogenic fluid (e.g., dry ice, liquid carbon dioxide, liquid argon, liquid nitrogen, etc.) to produce a low-temperature environment in the system. The low-temperature environment chills the polymer source below its glass transition point to facilitate grinding in a mill that applies impact or shear, such as a jet-mill. Regardless of the technique employed, the ground recycled feedstock particles may have any desired mean diameter, typically within a range of from about 0.1 to about 5,000 micrometers, in some embodiments from about 0.2 to about 2,000 micrometers, and in some embodiments, from about 1 to about 1,000 micrometers, such as determined by optical microscopy.

As shown in FIG. 1, the PA66 waste feedstock may be supplied to the reactor vessel 14 in combination with adipic acid and water to form an aqueous reaction mixture. It should of course be understood that adipic acid and water need not be supplied separately. For example, the adipic acid may be pre-dissolved in water to form an aqueous solution that is supplied to the reactor vessel 14 in combination with the PA66 feedstock. Regardless, the concentration of each component of the mixture may be selectively controlled to help achieve the desired results. For instance, the PA66 feedstock typically constitutes from about 5 wt. % to about 60 wt. %, in some embodiments from about 5 wt. % to about 40 wt. %, in some embodiments from about 10 wt. % to about 35 wt. %, and in some embodiments, from about 15 wt. % to about 30 wt. % of the reaction mixture. Adipic acid may likewise constitute from about 3 wt. % to about 75 wt. %, in some embodiments from about 10 wt. % to about 75 wt. %, in some embodiments from about 10 wt. % to about 60 wt. %, in some embodiments from about 15 wt. % to about 50 wt. %, and in some embodiments, from about 20 wt. % to about 35 wt. % of the reaction mixture, while water may constitute from about 0 wt. % to about 80 wt. %, in some embodiments from about 35 wt. % to about 75 wt. %, and in some embodiments, from about 40 wt. % to about 70 wt. % of the reaction mixture. Also, if desired, a catalyst may also be supplied to the reactor vessel 14 to accelerate the reaction. Suitable catalysts may include, for instance, phosphate catalysts, such as phosphoric acid, boron phosphate, etc.

In some embodiments, a weight ratio of the adipic acid to the PA66 in the reaction mixture may be from about 0.1:1 to about 4:1. It was surprisingly found that the process can successfully be performed using relatively small amounts of adipic acid. For example, in some embodiments, the weight ratio of the adipic acid to the PA66 in the reaction mixture may be less than 1:1, in some embodiments, less about 3:4 or less, in some embodiments about 1:2 or less, in some embodiments about 1:4 or less, in some embodiments, about 1:6 or less and in some embodiments, about 1:8 or less. The use of smaller amounts of adipic acid can lead to better process and separation efficiency.

Once supplied to the reactor vessel 14, the reaction mixture may be heated to a temperature to initiate dissolution and depolymerization of the PA66. Typically, the temperature ranges from about 95° C. to about 225° C., in some embodiments from about 110° C. to about 210° C., and in some embodiments, from about 140° C. to about 200° C. If desired, the reaction temperature can be maintained constant throughout the course of the reaction or can be varied. The reaction pressure during depolymerization is maintained at a value from 0 to 350 psig, in some embodiments from about 50 to about 300 psig, and in some embodiments, from about 100 to about 250 psig. The reaction pressure may be controlled by the vent setting. The length of the dissolution and depolymerization process is typically a function of the reaction temperature, process design, etc., but is typically from about 10 to about 500 minutes, in some embodiments from about 20 to about 350 minutes, and in some embodiments, from about 40 to about 150 minutes.

If desired, the reactor vessel 14 may be optionally depressurized after the reaction to remove water from the solution. During this process, the solution can be maintained in liquid phase to minimize precipitation of the PA66 by ensuring that the temperature of the mixture remains above the freezing temperature. In most embodiments, for instance, the mixture may be maintained at a temperature from about 5° C. to about 40° C. above the freezing temperature, in some embodiments from about 10° C. to about 30° C. above the freezing temperature, and in some embodiments, from about 15° C. to about 25° C. above the freezing temperature. For example, the freezing temperature may be from about 100° C. to about 160° C., in some embodiments from about 115° C. to about 155° C., and in some embodiments, from about 120° C. to about 150° C., such that the mixture may thus be maintained at a temperature of from about 120° C. to about 200° C., in some embodiments from about 130° C. to about 195° C., and in some embodiments, from about 150° C. to about 190° C. within the reactor vessel 14.

As indicated above, the dissolution, depolymerization, and optional water removal steps described above form an oligomeric mixture containing adipic acid, PA66 oligomer(s), impurities, and optionally water. The oligomeric mixture exhibits a melting temperature that is characteristic of a eutectic mixture in that the melting temperature is less than pure PA66, such as from about 110° C. to about 220° C., in some embodiments from about 120° C. to about 200° C., and in some embodiments, from about 140° C. to about 190° C., such as determined by differential scanning calorimetry in accordance with ISO 11357-1:2023 (during 2^{nd} heat cycle). The viscosity of the solution is also generally low, such as less than about 120 centipoise, in some embodiments less than about 80 centipoise, in some embodiments from about 1 to about 60 centipoise, and in some embodiments, from about 2 to about 50 centipoise, as determined using a Brookfield viscometer at a temperature of 155° C. and shear rate of 15 s⁻¹ in accordance with ASDM D789-19 or ISO 307:2019.

It is also typically desired that the ratio of amino end groups to carboxyl end groups is selectively controlled within a specific range to achieve the desired inherent viscosity for the resulting PA66 oligomer(s). The ratio may, for example, range from about 0.1 to about 0.8, in some embodiments from about 0.15 to about 0.7, and in some embodiments, from about 0.2 to about 0.6. For instance, the amino end groups may be present in an amount of from about 100 to about 300, in some embodiments from about 120 to about 280, and in some embodiments, from about 150 to about 250 milliequivalents (“meq”) per kilogram (“kg”) of an oligomer, while the carboxyl end groups may likewise be present in an amount of from about 500 to about 2,000, in some embodiments from about 600 to about 1,800, and in some embodiments, from about 800 to about 1,400 meq/kg of an oligomer. The resulting inherent viscosity (“IV”) of the PA66 oligomer(s) may likewise be from 0.1 to about 0.6, in some embodiments from about 0.15 to about 0.55, and in some embodiments, from about 0.2 to about 0.5.

To help achieve the desired level of amino and carboxyl end groups, as well as the target inherent viscosity, an aliphatic diamine may optionally be placed into contact with the reaction mixture and/or the oligomeric mixture after it is formed (separately or within the reactor vessel 14). When employed, the aliphatic diamines typically have from 6 to 40 carbon atoms, in some embodiments from 7 to 30 carbon atoms, in some embodiments from 8 to 24 carbon atoms, in some embodiments from 9 to 22 carbon atoms, and in some embodiments, from 10 to 20 carbon atoms. Examples of such diamines may include, for instance, linear aliphatic alkylenediamines, such as 1,6-hexanediamine (hexamethylenediamine), 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof.

Due to its relatively low viscosity and melting temperature, the oligomeric mixture may be readily separated to remove impurities. Examples of suitable solid-liquid separation techniques may include, for instance centrifugal separation (e.g., decanter, disc stack, etc.), membrane filters, sieving, external force separation (e.g., electric field, magnetic field, gravitational field, etc.), ion exchange, chromatography, extraction, etc. In one embodiment, for example, the solution may be supplied to a filtration unit 20 within which the solution is contacted with one or more filter media to separate the solution into a liquid stream containing the PA66 oligomer(s)/adipic acid mixture and a solid phase filter cake containing insoluble impurities (e.g., other polymers, inorganic materials, etc.). The filter media may vary as known in the art and may include, for instance, glass wool supported by wire mesh, glass fiber fabric, polymer fabric, metals (e.g., stainless steel), etc. Generally, the filter media contains pores that are relatively small, such as from about 0.1 to about 500 micrometers, in some embodiments from about 0.2 to about 250 micrometers, and in some embodiments, from about 0.3 to about 10 micrometers. The number of filter media vary as desired, but is typically from 1 to 5, in some embodiments from 1 to 3, and in some embodiments, from 1 to 2. Regardless of the size or number of filter media employed, other aspects of the filtration process may also be employed to achieve the desired degree of separation. For example, during all or a portion of the filtration process, the solution may be heated to an elevated temperature that is above the melting temperature of the oligomeric mixture. For example, the solution may be heated to an elevated temperature of from about 100° C. to about 200° C., in some embodiments from about 120° C. to about 180° C., and in some embodiments, from about 130° C. to about 170° C. This may be accomplished using techniques known in the art, such as by using a filtration unit containing band heaters. Heating typically occurs for a time period sufficient to help ensure complete melting and/or depolymerization, such as for a time period of from about 10 to about 500 minutes, in some embodiments from about 20 to about 350 minutes, and in some embodiments, from about 60 to about 250 minutes. The filtration process may also be assisted through the application of a pressure differential to the oligomeric mixture as it passes through the filter media. The pressure differential may, for example, be provided by the supply of a gas (e.g., inert gas) to the filtration unit at a pressure of from about 50 to about 200 psig, in some embodiments from about 60 to about 150 psig, and in some embodiments, from about 70 to about 100 psig.

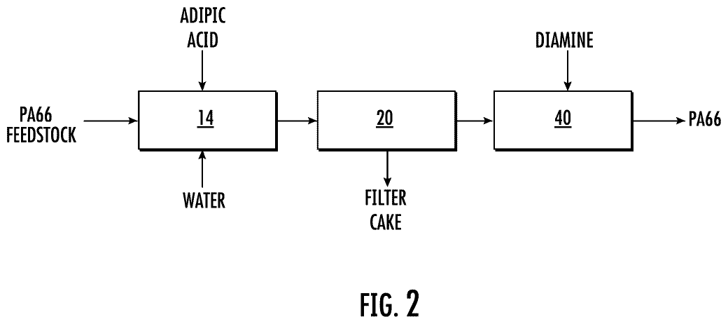

The filtration containing PA66 oligomer(s) and excess adipic acid may thereafter be recovered from the filtration unit 20. At this stage, the excess adipic acid can optionally be recovered by precipitating the PA66 oligomer(s) from the solution. Precipitation may be initiated at a temperature of from about 110° C. to about 190° C., in some embodiments from about 115° C. to about 180° C., and in some embodiments, from about 120° C. to about 160° C. Once separated, the excess adipic acid may be recycled into the aforementioned process or employed as a reactant in a polymerization process. Likewise, the precipitated PA66 oligomer(s) may be provided to an existing polymerization system 30 during which the oligomer(s) are reacted with an aliphatic amine (e.g., hexamethylene diamine) to repolymerize the oligomer(s) into a PA66 polymer having the desired target molecular weight and inherent viscosity. Of course, one benefit of employing adipic acid in the initial dissolution and depolymerization process is that it is not always necessary to remove it from the solution prior to repolymerization. Referring to FIG. 2, for example, an additional embodiment is shown in which the solution containing PA66 oligomer(s) and excess adipic acid is supplied directly to a to an existing polymerization system 40 during which the oligomer(s) are reacted with an aliphatic amine (e.g., hexamethylene diamine) to repolymerize the oligomer(s) into a PA66 polymer having the desired target molecular weight and inherent viscosity. Regardless of the particular method employed, the resulting recycled PA66 generally has a melting temperature of from about 240° C. to about 290° C., in some embodiments from about 250° C. to about 280° C., and in some embodiments, from about 255° C. to about 270° C., such as determined using differential scanning calorimetry in accordance with 11357-3:2018.

The present invention may be better understood with reference to the following examples and test methods.

### Test Methods

End Groups: The carboxyl end groups may be determined in accordance with ASTM D7409-15 (2020). The amino end groups may be determined in accordance with ASTM D6979-03 or ISO 25761:2014.

Inherent Viscosity. The inherent viscosity (“IV”) may be determined in accordance with ISO 307:2019, ASTM D2857-22, or ISO 1628-1:2021.

Average degree of polymerization (DP): DP can be determined according to the following equation:

$$D P = \frac{2 * 1 {0}^{6}}{11 3.156 ( \frac{g}{m o l} ) * Sum of ends ( \frac{m e q}{k g} )}$$

where:

Sum of ends (meq/kg)=Amine ends+Carboxyl ends.

Number average molecular weight: Number average molecular weight (Mₙ) in g/mol can be determined according to the following equation:

$${M}_{n} = \frac{2 * 1 {0}^{6}}{Sum of ends ( \frac{m e q}{k g} )}$$

### Examples 1-2

Pellets containing 65 wt. % PA66 and 35 wt. % glass fibers were ground and dried overnight (90° C., 19 mmHg). A magnetic agitator was first placed on the bottom of a quartz tuber reactor vessel, and then water, adipic acid (powder) and the ground pellets were added to the reactor vessel. The reactor vessel was sealed and heated to the target temperature. In some cases, phosphoric acid was added as a catalyst. Adipic acid fully melted at 105° C. Once the desired temperature and pressure are achieved, the conditions were held for 90 minutes. Thereafter, a pressure let-down phase was initiated by venting the steam. At the end of the pressure let-down phase when atmospheric pressure was reached, the temperature set-point was slowly reduced until the onset of freezing was observed. Table 1 below shows the different experiments performed.

TABLE 1

| | PA 66 | Adipic Acid | Water | Phosphoric | Temp | Pressure | Tm (° C.) |
|---|---|---|---|---|---|---|---|
| | (wt. %) | (wt. %) | (wt. %) | Acid (ppm) | (° C.) | (psig) | (DSC 2^{nd} heat) |
| Example 1 | 12 | 18 | 70 | 1000 | 165 | 100 | 130 |
| Example 2 | 12 | 18 | 70 | 0 | 165 | 100 | 135 |

A single melting point was observed in the range of 130° C. to 135° C. This reflects a eutectic behavior that is very favorable for a purification process because the polymeric solution can be kept in liquid form at a relatively low temperature for filtration.

### Examples 4-6

Water, adipic acid (powder) and unreinforced polyamide 66 pellets (melt flow rate of 23 g/10 min at 1.2 kg, 275° C.) were initially added to an autoclave (10 liter). The autoclave was purged with nitrogen, then heated to a target temperature and pressure. Once the desired temperature and pressure are achieved, the conditions are held for 90 minutes. A pressure let-down phase is started by venting the steam. At the end of pressure let-down phase when atmospheric pressure is reached, the autoclave is then drained. The recovered solid material recovered is ground and dried overnight. Thereafter, a sample is taken for DSC analysis to determine the melt temperature (Tm). Table 2 below shows the different experiments performed.

TABLE 2

| | | Adipic | | | | Tm (° C.) |
|---|---|---|---|---|---|---|
| | PA 66 | Acid | Water | Temp | Pressure | (DSC 2^{nd} |
| | (wt. %) | (wt. %) | (wt. %) | (° C.) | (psig) | heat) |
| Example 4 | 16 | 24 | 60 | 190 | 100 | 135 |
| Example 5 | 20 | 30 | 50 | 190 | 100 | 133 |
| Example 6 | 18 | 22 | 60 | 150 | 75 | 141 |

A single melting point was observed in the range of 135° C. to 141° C. This reflects a eutectic behavior that is very favorable for a separation process because the polymeric solution can be kept in liquid form at a relatively low temperature for filtration.

### Examples 7-9

The ability to use hexamethylenediamine (“HMD”) in combination with PA66/adipic acid was demonstrated. In the examples, PA66 pellets are dissolved in adipic acid, and then HMD is added and the resulting mixture is polymerized to form a PA66 salt solution with suspended recovered PA66 oligomers. Dissolution occurred at a pressure from 60 to 180 psi, temperature from 60° C. to 90° C., and time period of 60 to 90 minutes. Polymerization occurred at a temperature of 260° C. at a pressure up to 250 psig. Three types of vessels were employed for these experiments: quartz tube (Q/T), 1 liter, and 10 liter autoclaves. Table 3 below shows the end group analysis and inherent viscosity (IV) for each example.

TABLE 3

| Sample | Vessel | Inherent | Amine Ends | Carboxyl Ends |
|---|---|---|---|---|
| Identification | Type | Viscosity | (meq/kg) | (meq/kg) |
| PA66 Pellets | — | 0.95 | 51 | 81 |
| Example 7 | Q/T | — | 146 | 92 |
| Example 8 | 1 L | 0.99 | 51 | 125 |
| Example 9 | 10 L | 0.67 | 162 | — |

### Example 10

Different PA66 post-consumer recycle (PCR) samples were initially obtained from five (5) different sources derived from carpet waste material. The PCR samples ranged from high, medium and low purity pelletized to un-pelletized fluffy samples with low purity. As noted in Table 4 below, the main impurities in the PCR are polypropylene, calcium carbonate, and other inorganic material (e.g., titanium dioxide).

TABLE 4

| | PA66 | PP | CaCO₃ | Other |
|---|---|---|---|---|
| PCR type | (wt. %) | (wt. %) | (wt. %) | (wt. %) |
| High purity pellets | 98 | — | 1.5 | — |
| (Source #1) | | | | |
| Low purity pellets | 75 | 9 | 13 | 3 |
| (Source #1) | | | | |
| High purity pellets | 95 | 0 | 4 | — |
| (Source #2) | | | | |
| Medium purity pellets | 84 | 7 | 7 | 2 |
| (Source #3) | | | | |
| Low purity Fluffy | 77 | 15 | 5.4 | 1.6 |
| (Source #4) | | | | |
| Low purity Fluffy | 73 | 15 | 9.5 | 1.5 |
| (Source #5) | | | | |

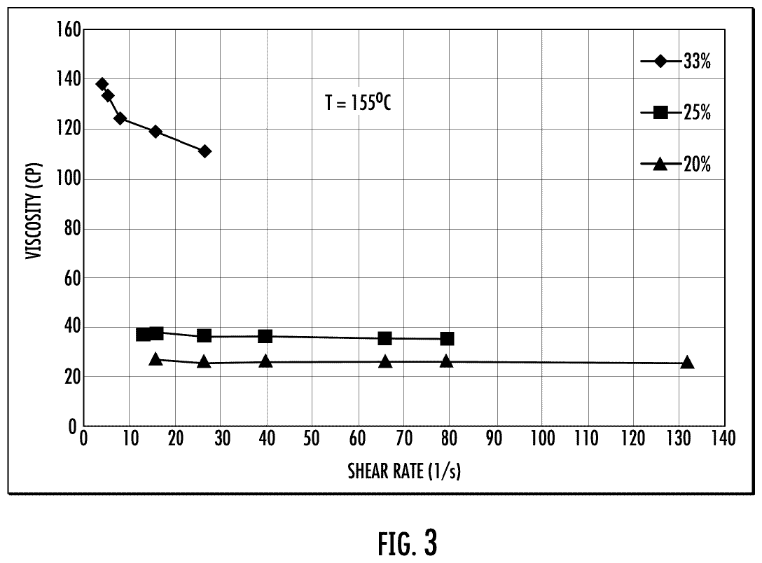

The PCR pellets noted above were processed with an adipic acid solution in the 1-liter autoclave to dissolve the PA66 in the adipic acid and produce a solid eutectic mixture. Dissolution occurred at a pressure from 60 to 180 psi, temperature from 60° C. to 90° C., and time period of 60 to 90 minutes. The viscosities of various PCR samples (33% impurities, 25% impurities, and 20% impurities) were tested with a Brookfield viscometer at a temperature of 155° C. and shear rate ranging from 10 to 140 s⁻¹) in accordance with ASTM D3418-21. The viscosity results are shown in FIG. 3.

After dissolution, low impurity PCR samples (up to 30% impurities) were collected for filtration. More particularly, 20 to 40 grams of a sample were placed in a filtration unit containing filter made of sintered stainless steel having three optional levels of pore sizes of 1 μm, 60 μm, and 120 μm (filter diameter of 2 inches). The sample was then heated by band heaters to a temperature of 150° C. to 155° C. for a heat soaking time period ranging from 20 to 120 minutes. After the sample reached the target temperature, nitrogen pressure was applied to achieve a pressure differential of 70 to 150 psig and the drain valve was slowly opened to discharge the filtrate. The drain line was heat traced to avoid freezing and subsequent plugging of the drain line. The resulting filtrate was collected in a stainless steel container. At the end of the filtration, when the filter pressure dropped to atmospheric pressure, the heaters were turned off and the filter assembly was opened to remove the filter cake. The filter media, drain line, filtrate collection container were all weighed out before and after the filtration to calculate the filtration yield according to the following equation: Filtration Yield=(weight of PA66/adipic acid mixture in the filtrate)/(weight of PA66/adipic mixture in the filtered sample)*100. Table 5 below shows the filtration yield for various tests.

TABLE 5

| | Heat | | | Filter Pore | Filtration |
|---|---|---|---|---|---|
| Low Purity | Soaking | Sample | Pressure | Size | Yield |
| PCR Type | Time (min) | Size (g) | (psig) | (μm) | (wt. %) |
| Source #1 | 20 | 40 | 70 | 125 | 52 |
| | 20 | 40 | 100 | 60 | 54 |
| | 20 | 40 | 100 | 1 | 56 |
| | 20 | 20 | 100 | 1 | 72 |
| | 20 | 20 | 150 | 1 | 78 |
| Source #4 | 120 | 20 | 50 | 1 | 96 |
| | — | 20 | 100 | 1 | 45 |
| | 120 | 20 | 100 | 1 | 88 |
| Source #5 | 120 | 20 | 100 | 1 | 89 |
| | 120 | 40 | 150 | 1 | 92 |
| | 120 | 60 | 200 | 1 | 98 |

During testing, it was observed that the 1 μm filters tended to show better yields as the 60 and 125 μm filters often caved in and eventually ruptured. In addition, increased heat soaking times often resulted in better yields, which was likely due to the fact that the samples were not completely melted during the short heat soaking times and/or the sample underwent further de-polymerization and thus and had a lower viscosity, which improved yield.

### Examples 11-12

PA66 pellets, adipic acid, and water were heated up to a target temperature in a round bottom flask. Once the desired temperature was reached, the conditions were held for 16 hours and 24 hours, respectively. The conditions are summarized below.

| | PA 66 | Adipic Acid | Water | Temp | Pressure | Time |
|---|---|---|---|---|---|---|
| | (wt. %) | (wt. %) | (wt. %) | (° C.) | (psig) | (h) |
| Example 11 | 19 | 31 | 50 | 100 | 0 | 16 |
| Example 12 | 19 | 31 | 50 | 100 | 0 | 24 |

No depolymerization or any other change was observed under these conditions.

### Examples 13-14

Ground PA66 powder, adipic acid, and water were heated up to a target temperature in a round bottom flask under continuous stirring. Once the desired temperature was reached, the conditions were held for 16 hours and 24 hours, respectively. The conditions are summarized below.

| | PA 66 | Adipic Acid | Water | Temp | Pressure | Time |
|---|---|---|---|---|---|---|
| | (wt. %) | (wt. %) | (wt. %) | (° C.) | (psig) | (h) |
| Example 13 | 19 | 31 | 50 | 100 | 0 | 16 |
| Example 14 | 19 | 31 | 50 | 100 | 0 | 24 |

No depolymerization or any other change was observed under these conditions.

### Example 15

Ground PA66 powder, adipic acid, hexamethylene diamine (HMD), and water were heated up to a target temperature in a round bottom flask. The temperature of the mixture gradually increased from 100° C. to 110° C. after 3 hours, increased to 125° C. after 6 hours and to 135° C. after 9 hours of heat soaking. The mixture dissolved completely at 135° C. and formed a clear solution. The conditions are set forth in more detail below.

| | PA 66 | Adipic | | | | | |
|---|---|---|---|---|---|---|---|
| | powder | Acid | HMD | Water | Pressure | Temp | Time |
| | (wt. %) | (wt. %) | (wt. %) | (wt. %) | (psig) | (° C.) | (h) |
| Example | 9 | 5 | 36 | 50 | 0 | 110 | 3 |
| 15 | | | | | | 125 | 6 |
| | | | | | | 135 | 9 |

A product with DSC melting temperatures ranging from 110-150° C. was obtained, which can be attributed to monomeric interactions with the process mix. The mix obtained from the process was washed repeatedly to isolate the oligomers and to remove any adipic acid or HMD present, and was then dried before analysis. PA66 oligomers with a final degree of polymerization (DP) between 8-12, and a melting temperature ranging between 230-258° C. were obtained at the end of the process.

### Example 16

PA66 pellets, adipic acid, hexamethylene diamine (HMD), and water were heated up to a target temperature in a round bottom flask. The temperature of the mixture gradually increased from 100° C. to 110° C. after 9 hours, increased to 125° C. after 16 hours and to 135° C. after 24 hours of heat soaking. The conditions are set forth in more detail below.

| | PA 66 | Adipic | | | | | |
|---|---|---|---|---|---|---|---|
| | pellets | Acid | HMD | Water | Pressure | Temp | Time |
| | (wt. %) | (wt. %) | (wt. %) | (wt. %) | (psig) | (° C.) | (h) |
| Example | 9 | 5 | 36 | 50 | 0 | 110 | 9 |
| 16 | | | | | | 125 | 16 |
| | | | | | | 135 | 24 |

A product with DSC melting temperatures ranging from 110-150° C. was obtained, which can be attributed to monomeric interactions with the process mix. The mix obtained from the process was washed repeatedly to isolate the oligomers and to remove any adipic acid or HMD present and was dried before analysis. PA66 oligomers with a final degree of polymerization (DP) between 8-12, and a melting temperature ranging between 230-258° C. were obtained at the end of the process.

### Example 17

PA66 powder, adipic acid, HMD, and water were heated up to a target temperature in a 1 L reactor. Once the desired temperature was reached, the conditions were held up to 1.5 hours. Dissolution occurred at 170° C., but the contents remained dissolved at 165° C. at 1.5 hours. The conditions are set forth in more detail below.

| | PA66 | HMD | Adipic Acid | Water | Temp | Pressure | Hold |
|---|---|---|---|---|---|---|---|
| | (wt. %) | (wt. %) | (wt. %) | (wt. %) | (° C.) | (psig) | Time (h) |
| Example 17 | 9 | 5 | 36 | 50 | 170-165 | 60-110 | 1-1.5 |

### Examples 18-19

Automotive PCR parts (−10 mesh) containing 22 wt. % glass was used along with adipic acid and water. The contents of the reactor were heated to target temperatures listed in the table and checked for solubility.

| | | Adipic | | | | Hold |
|---|---|---|---|---|---|---|
| | PCR | Acid | Water | Temp | Pressure | Time |
| | (wt. %) | (wt. %) | (wt. %) | (° C.) | (psig) | (h) |
| Example 18 | 20 | 30 | 50 | 165 | 60-110 | 1.5 |
| Example 19 | 20 | 30 | 50 | 170 | 60-110 | 1 |

For Example 18, partial dissolution of the PCR was observed at 1.5 hours. For Example 19, complete dissolution occurred immediately, with depolymerization occurring to give a filterable solution after 1 hour.

### Examples 20-23

Automotive PCR parts (−10 mesh) containing 15 wt. % glass was used along with adipic acid and water. The contents of the reactor were heated to a target temperature of 170° C., was allowed to heat soak for 1 to 3 hours. A filterable solution was achieved at a hold time of 1 hour through 20-100 mesh. Filtrates with residual insoluble inorganics content less than 2 wt. % and a melting temperature of 152° C. was achieved with 60 mesh as determined from ash content and DSC analyses, respectively.

| | PCR | Adipic Acid | Water | Temp | Pressure | Hold | Tm (° C.) |
|---|---|---|---|---|---|---|---|
| | (wt. %) | (wt. %) | (wt. %) | (° C.) | (psig) | Time (h) | (DSC 2^{nd} heat) |
| Example 20 | 20 | 30 | 50 | 170 | 60-110 | 1 | 152 |
| Example 21 | 20 | 30 | 50 | 170 | 60-110 | 1.5 | — |
| Example 22 | 20 | 30 | 50 | 170 | 60-110 | 2 | — |
| Example 23 | 20 | 30 | 50 | 170 | 60-110 | 3 | — |

### Example 24

PA66 powder along with adipic acid and water were heated up to target temperature in a 1 L reactor under autogenous pressure. Once the desired temperature was reached, the conditions were held for 1 hour, after which a filterable solution consisting of PA66 oligomer, adipic acid and water was obtained. The conditions are set forth in more detail below.

| | PA 66 | Adipic Acid | Water | Temp | Pressure |
|---|---|---|---|---|---|
| | (wt. %) | (wt. %) | (wt. %) | (° C.) | (psig) |
| Example 24 | 30 | 50 | 20 | 160-165 | 50-80 |

A dried product was obtained consisting of a mixture of PA66 oligomer and adipic acid that had a DSC melting temperature around 142-144° C. The product mixture was washed repeatedly to isolate the oligomers and to remove any free adipic acid present and was dried before analysis. The oligomer was found to have an average degree of polymerization (DP) of 8, amine ends in a concentration of 443 meq/kg, carboxyl ends in a concentration of 1783 meq/kg, a number average molecular weight (Mₙ) of 899 g/mol, an IV of 0.18 g/dL, and a melting temperature of 244° C. upon analysis.

### Example 25

The mixture of adipic acid and oligomer produced using Example 24 was added to a 10 L autoclave along with water, HMD, and a catalyst package commonly used in nylon polymerization. Polymerization is done according to the standard autoclave process for PA66 known in the art. PA66 polymer with a recycled content of 28.1% having an average Mₙ of 15204 g/mol was produced. Properties of the polymer are set forth below.

| | Dried | | | | | | | | |
|---|---|---|---|---|---|---|---|---|---|
| | oligomer/AA | | | Amine | Carboxyl | | | | Tₘ |
| | mixture | Water | HMD | ends | ends | | Mₙ | IV | DSC |
| | (wt. %) | (wt. %) | (wt. %) | (meq/kg) | (meq/kg) | DP | (g/mol) | (g/dL) | (° C.) |
| Example 25 | 44 | 35 | 21 | 24 | 107 | 134 | 15204 | 1.20 | 262 |

### Examples 26-29

To test the effect of lower concentration of adipic acid for depolymerization, the following set of experiments were conducted. Ground PA66 powder along with adipic acid, and water were added to a Quartz Tube reactor and heated up to target temperature under autogenous pressure. Once the desired temperature was reached, the conditions were held for at least 1 hour. The product obtained was washed repeatedly to isolate the oligomers and to remove any free adipic acid present and was dried before analysis. The process conditions and product analysis are set forth below.

| | | Adipic | | | | Amine | Carboxyl | | | | Tₘ |
|---|---|---|---|---|---|---|---|---|---|---|---|
| | PA 66 | Acid | Water | Temp | Pressure | ends | ends | | Mₙ | IV | DSC |
| | (wt. %) | (wt. %) | (wt. %) | (° C.) | (psig) | (meq/kg) | (meq/kg) | DP | (g/mol) | (g/dL) | (° C.) |
| Example 26 | 30 | 30 | 40 | 170 | 109-112 | 432 | 2185 | 9 | 1067 | 0.20 | 243 |
| Example 27 | 40 | 20 | 40 | 175 | 120-127 | 482 | 1228 | 10 | 1169 | 0.23 | 255 |
| Example 28 | 48 | 12 | 40 | 185 | 160-170 | 414 | 1488 | 9 | 1051 | 0.22 | — |
| Example 29 | 54 | 6 | 40 | 190 | 170-173 | 339 | 919 | 14 | 1590 | 0.32 | 254-264 |

### Examples 30-33

The PA66 in Examples 24 and 26-28 were replaced with ground automotive PCR parts (−5 mesh) containing 33 wt. % glass and having a melting temperature of 261° C. (IV 1.1 g/dL, Mₙ of 11337 g/mol). The conditions and results are set forth below.

| | | Adipic | | | | Amine | Carboxyl | | | | Tₘ |
|---|---|---|---|---|---|---|---|---|---|---|---|
| | PCR | Acid | Water | Temp | Pressure | ends | ends | | Mₙ | IV | DSC |
| | (wt. %) | (wt. %) | (wt. %) | (° C.) | (psig) | (meq/kg) | (meq/kg) | DP | (g/mol) | (g/dL) | (° C.) |
| Example 30 | 28 | 32 | 40 | 170 | 107-132 | 455 | 1105 | 11 | 1282 | 0.24 | 252 |
| Example 31 | 36 | 24 | 40 | 170 | 202-222 | 399 | 1036 | 12 | 1393 | 0.29 | 254 |
| Example 32 | 45 | 15 | 40 | 185 | 123-126 | 353 | 1078 | 12 | 1397 | 0.25 | 256 |
| Example 33 | 56 | 4 | 40 | 190 | 160-198 | 406 | 1226 | 11 | 1226 | 0.22 | 252 |

### Example 34

Ground automotive PCR parts (−5 mesh) containing 33 wt. % glass and having a melting temperature of 261° C. (IV 1.1 g/dL, Mₙ of 11337 g/mol) were added to a 1 L reactor along with water and adipic acid. The reactor was heated up to target temperature. Once the desired temperature was reached, the conditions were held for 1 hour. At the end of the hold, the contents of the reactor were passed through a filtration unit consisting of a 20 mesh and 80 mesh in series to separate glass and other inorganic material from the mixture of adipic acid, oligomer and water. The filtered product mixture after drying had a DSC melting temperature 135° C. and an insoluble inorganic (glass) content of 1.4 wt. %, which was determined from washing the sample.

In order to demonstrate the successful depolymerization of into oligomers, about 20 g of the filtered and dried oligomer and adipic acid product mixture was washed repeatedly to isolate the oligomers and to remove any free adipic acid present and was dried before analysis. Analysis confirmed successful depolymerization of nylon in the automotive PCR to an average DP of 10 and IV of 0.2 g/dL, as shown in the table below.

| | | Adipic | | | | Amine | Carboxyl | | | | Tₘ |
|---|---|---|---|---|---|---|---|---|---|---|---|
| | PCR | Acid | Water | Temp | Pressure | ends | ends | | Mₙ | IV | DSC |
| | (wt. %) | (wt. %) | (wt. %) | (° C.) | (psig) | (meq/kg) | (meq/kg) | DP | (g/mol) | (g/dL) | (° C.) |
| Example 34A | 28 | 32 | 40 | 180 | 125-145 | 474 | 1342 | 10 | 1102 | 0.20 | 250 |

Repolymerization of the PCR nylon oligomer and adipic acid mixture obtained from the 1 L reactor is demonstrated in the quartz tube reactor. The dried PCR and adipic acid mixture along with water, HMD, and a catalyst package commonly used in nylon polymerization was added to the quartz tube reactor and was polymerized according to the standard autoclave process for PA66 known in the art. The properties of the final polymer containing recycled PCR automotive parts are shown in the table below.

| | Dried | | | | | | | | |
|---|---|---|---|---|---|---|---|---|---|
| | oligomer/AA | | | Amine | Carboxyl | | | | Tₘ |
| | mixture | Water | HMD | ends | ends | | Mₙ | IV | DSC |
| | (wt. %) | (wt. %) | (wt. %) | (meq/kg) | (meq/kg) | DP | (g/mol) | (g/dL) | (° C.) |
| Example 34B | 49 | 28 | 23 | 64 | 138 | 87 | 9901 | 1.07 | 263 |
| Example 34C | 49 | 28 | 23 | 114 | 83 | 90 | 10142 | 1.19 | 261 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A method for forming an oligomeric mixture containing a polyamide 66 oligomer, the method comprising heating a reaction mixture within a reactor vessel that contains adipic acid, water, and a waste feedstock that includes polyamide 66 and one or more impurities, wherein a weight ratio of the adipic acid to the polyamide 66 is less than 1:1.

2. The method of claim 1, wherein the waste feedstock is derived from a post-industrial recycled material.

3. The method of claim 1, wherein the waste feedstock is derived from a post-consumer recycled material.

4. The method of claim 1, wherein the waste feedstock is formed by a process that includes grinding a waste product containing polyamide 66 and one or more impurities.

5. The method of claim 1, wherein the waste feedstock contains impurities in an amount of from about 1 wt. % to about 40 wt. %.

6. The method of claim 1, wherein the waste feedstock constitutes from about 5 wt. % to about 60 wt. % of the reaction mixture, adipic acid constitutes from about 10 wt. % to about 60 wt. % of the reaction mixture, and water constitutes from about 0 wt. % to about 80 wt. % of the reaction mixture.

7. The method of claim 1, wherein the reaction mixture is heated to a temperature of from about 95° C. to about 225° C.

8. The method of claim 1, further comprising supplying an aliphatic diamine to the reactor vessel.

9. The method of claim 1, further comprising removing water from the oligomeric mixture after the reaction mixture is heated.

10. An oligomeric mixture containing a polyamide 66 oligomer, adipic acid, and impurities, wherein the melting temperature of the oligomeric mixture is from about 110° C. to about 265° C. as determined by differential scanning calorimetry in accordance with ISO 11357-1:2023.

11. The oligomeric mixture of claim 10, wherein the viscosity of the solution is less than about 120 centipoise, as determined using a Brookfield viscometer at a temperature of 155° C. and shear rate of 15 s⁻¹.

12. The oligomeric mixture of claim 10, wherein the polyamide 66 oligomer has amino end groups and carboxyl end groups, wherein the ratio of the amino end groups to the carboxy end groups is from about 0.1 to about 0.8.

13. The oligomeric mixture of claim 10, wherein the polyamide 66 oligomer has an inherent viscosity of from about 0.1 to about 0.6 deciliters per gram as determined at a temperature of 25° C.

14. The oligomeric mixture of claim 10, further comprising water.

15. A method for recycling a polyamide 66 waste feedstock, the method comprising:
separating an oligomeric mixture, wherein the oligomeric mixture contains adipic acid, a polyamide 66 oligomer derived from the waste feedstock, and impurities, wherein the separation results in the formation of a solid cake containing the impurities and a liquid stream containing the polyamide 66 oligomer and adipic acid; and
repolymerizing the polyamide 66 oligomer.

16. The method of claim 15, wherein the polyamide 66 oligomer is precipitated from the liquid stream and thereafter repolymerized.

17. The method of claim 15, wherein the liquid stream is supplied to a polymerization system to repolymerize the polyamide 66 oligomer.

18. The method of claim 15, wherein the oligomeric mixture is placed into contact with one or more filter media, wherein the filter media contains pores having a size of from about 0.1 to about 500 micrometers.

19. The method of claim 15, wherein the oligomeric mixture is heated to a temperature of from about 100° C. to about 200° C. within the filtration unit for a time period of from about 10 to about 500 minutes.

20. The method of claim 15, wherein the repolymerized polyamide 66 has a melting temperature of from about 240° C. to about 290° C. and the oligomeric mixture has a melting temperature of from about 110° C. to about 220° C., as determined by differential scanning calorimetry in accordance with ISO 11357-1:2023.
